(19) United States
(12) Patent Application Publication
(10) Pub. No.: US 2026/0287142 A1
(43) Pub. Date: Sep. 24, 2026

(54) MODULAR STACKABLE LIGHT DIFFUSERS

(71) Applicant: 3form, LLC, Salt Lake City, UT (US)

(72) Inventors: Dax K. Pettibone, American Fork, UT (US); Ryan G. Smith, Seattle, WA (US); Guillaume Martin, Rochetoirin (FR)

(21) Appl. No.: 18/445,686

(22) Filed: Mar. 18, 2025

(51) Int. Cl. F21V 3/02; F21V 3/04; F21V 17/00

(52) U.S. Cl. CPC F21V 3/02; F21V 3/049; F21V 17/00

(57) ABSTRACT

Modular light fixtures can include collars, shades, and diffusers that can be combined to create various lighting configurations. The collars feature indexes that engage with the necks of the shades, which have slots to accommodate the diffusers. The diffusers can comprise connectors and fins, allowing them to be securely attached and aligned within the fixture.

### CROSS-REFERENCE TO RELATED APPLICATIONS

N/A.

### BACKGROUND OF THE INVENTION

### 1. Technical Field

The present invention pertains to modular stackable lighting systems and locking diffusers.

### 2. Background and Relevant Art

Conventional lighting systems often feature static designs that limit customization and adaptability. These systems may include fixed components that do not allow for easy replacement or modification, which can be problematic for users seeking to update their decor or repair damaged parts. Additionally, traditional lighting systems may rely on mechanical fasteners or adhesives that can be cumbersome to assemble and disassemble, potentially leading to wear and tear over time.

Furthermore, conventional lighting systems typically lack modularity or expandability, meaning users cannot easily change the appearance or functionality of their fixtures. This rigidity can be a significant drawback for those who desire a more dynamic, personalized lighting solution. The materials used in traditional lighting systems may also be limited in variety, restricting the range of aesthetic and functional effects that can be achieved.

Accordingly, there are a number of disadvantages in the art that can be addressed.

### BRIEF SUMMARY OF THE INVENTION

Implementations of the present invention comprise systems, methods, and apparatus related to modular lighting fixtures. In particular, implementations of the present invention can comprise collars, shades, and diffusers that enable a user or assembler to construct or reconfigure cost-effective modular light fixtures and diffuser bars that align with aesthetic and functional design goals.

A modular light fixture can comprise a collar having one or more indexes and one or more shades. Each of the one or more shades can have a necks that defines one or more slots. The modular light fixture can also comprise one or more diffusers and each of the one or more diffusers comprising a connector and one or more fins. The neck of the shades can selectively engage with the one or more indexes.

A locking diffuser for use in a modular light fixture can comprise an outer shell and an opening defined by the outer shell. Locking diffusers can also include a connector and one or more fins disposed on an outer surface of the outer shell.

A collar for use in modular light fixtures comprising a body having an upper surface and a lower surface. The collar may include one or more walls that extend from the lower surface of the body and one or more apertures that extend through the body. Collars can also comprise a connection element and one or more indexes that extend from the one or more walls.

A method of assembling a modular lighting fixture can comprise engaging a first diffuser with a second diffuser and coupling the first diffuser to the collar. The method may further include coupling a first shade to a second shade, slidably engaging the first and second shades to the first diffuser and the second diffuser.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a cross-sectional view of a modular light fixture of the present disclosure;

FIG. 2A illustrates a perspective view of a diffuser of the present disclosure;

FIG. 2B illustrates a perspective view of another embodiment of a diffuser of the present disclosure;

FIG. 2C illustrates a perspective view of a locking diffuser of the present disclosure;

FIG. 3 illustrates a cap of the present disclosure;

FIG. 4 illustrates a cross section of a modular light fixture including locking diffusers of the present disclosure;

FIG. 5 illustrates side perspective views of two shades of the present disclosure;

FIG. 6A illustrates a top perspective view of a collar of the present disclosure;

FIG. 6B illustrates a bottom perspective view of a collar of the present disclosure;

FIG. 6C illustrates a side cross-sectional view of a collar of the present disclosure;

FIG. 7 illustrates a method of assembling a modular light fixture;

FIG. 8 illustrates a sequence of inserting a film of the present disclosure; and

FIG. 9 illustrates various length diffusers of the present disclosure.

### DETAILED DESCRIPTION OF THE PREFERRED EMBODIMENTS

The present invention extends to systems, methods, and apparatus related to modular lighting fixtures. In particular, implementations of the present invention can comprise collars, shades, and diffusers that enable a user or assembler to construct or reconfigure cost-effective modular light fixtures that align with aesthetic and functional design goals.

Accordingly, the present disclosure relates to modular light fixtures and diffuser bars for use in public and private spaces. Specifically, the present disclosure provides modular light fixtures with removable shades and collars configured for tool-less locking and assembly. The shades can couple together to provide long totem or stacked light fixtures that can be hung from a ceiling or elevated position or mounted to a floor or wall surface. Users of modular light fixtures of the present disclosure will appreciate the configurability and customizability of the modular light fixtures as they allow a user or assembler to assemble or reconfigure the modular light fixture cheaply. For example, the diffuser bars of the present disclosure allow for continuous light emission throughout the entire length of the stacked lighting fixtures described herein. The diffuser bars also allow for the securing of the shades that make up the stacked lighting fixtures.

Users can assemble or reconfigure modular light fixtures of the present disclosure through a magnetic twist lock design. A user can insert a collar into the neck of a shade and twist it relative to the shade to engage elements of the collar with elements of a shade's neck. The user can also couple a diffuser bar with the collar such that the diffuser bar is securely held within the length of the modular light fixture.

Manufacturers of modular light fixtures of the present disclosure can construct shades, collars, and diffusers from Polylactic Acid (PLA), Polyethylene Terephthalate Glycol (PETG), Acrylonitrile Butadiene Styrene (ABS), Polycarbonate (PC), Thermoplastic Polyurethane (TPU), Polyvinyl Alcohol (PVA), Polyethylene (PE), or a similar material. Manufacturers may also construct shades, collars, and diffusers from metals, alloys, woods, composites, rubbers, etc. A manufacturer can choose the material based on the specific aesthetic or function design goal they have in mind for the modular lighting fixture. For example, PLA can be used in a 3D printer to produce components with a smooth finish that provides a sleek and clean aesthetic. Alternatively, PETG can be selected for its durability and flexibility characteristics.

The manufacturer can choose a colored material or utilize colored inserts (film) within the diffuser to change the perceived color of the light output by the modular light fixtures. The colored inserts may be transparent or semi-transparent films that can be rolled up to fit inside the diffusers. In the case of a diffuser bar, an assembler can install a single long film within all the diffusers that make up the diffuser bar rather than an individual film for each diffuser. By rolling the film up first, an assembler can allow the film to unfurl inside the diffusers, causing the film to be frictionally retained within the diffusers. Furthermore, a manufacturer can selectively texture the surfaces of the shades and diffusers. For example, a manufacturer may apply a rough texture to a diffuser of the present disclosure to change the light diffusion effects that the diffuser has. In another embodiment, however, a manufacturer may apply a smooth texture or patterned texture to the diffuser. The choice of texture can be dependent on aesthetic or functional purposes.

While the present disclosure teaches hanging light fixtures, modular light fixtures can be configured to reside on tables, floors, and walls. Additionally, the modularity of the modular light fixtures allows a user to easily disassemble and reassemble them for regular cleanings without having to undergo a complex disassembly process.

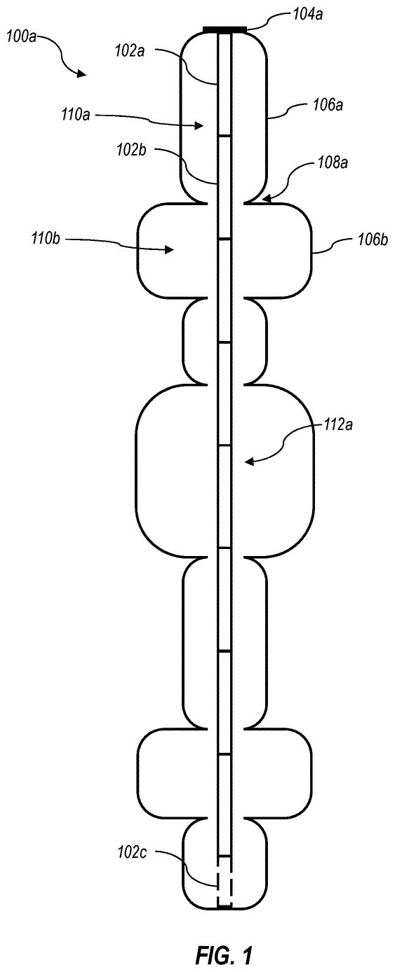

FIG. 1 illustrates modular light fixture 100a. Light fixture 100a can include shade 106a and 106b, diffuser 102a and 102b, and collar 104a. Light fixture 100a has seven total shades of the present disclosure. Users can selectively choose the overall length of their light fixtures by choosing how many shades they wish to include as well as the dimensions of each of the included shades. As shown, all shades in the light fixture 100a are substantially cylindrical. Manufacturers can construct the shades of the present disclosure into any geometric shape, such as squares, triangles, rectangles, or spheres. A manufacturer may also construct the shade in non-geometric shapes. Shade 106a can couple to shade 106b by way of joint 108a. A coupling element disposed on either shade 106a or 106b may selectively engage with a corresponding element disposed on the other shade. For example, a twist lock mechanism and/or magnets can secure shades 106a and 106b together at joint 108a. Joint 108a also joins the internal space 110a (defined by shade 106a) with internal space 110b (defined by shade 106b).

FIG. 1 shows that at least a portion of diffuser bar 112a is received within internal spaces 110a and 110b. Diffuser bar 112a can be centrally secured within internal spaces 110a and 110b and continue through internal spaces defined by additional shades. Diffuser bar 112a can include diffusers 102a and 102b, as well as any number of additional diffusers. An assembler can selectively secure the diffusers 102a and 102b together through various coupling or fastening means. An outer surface of diffuser 102b may abut an internal surface of joint 108a. Diffuser 102a and 102b may have uniform dimensions, such as overall length.

FIG. 1 shows that diffuser bar 112a may have a similar overall length to the combined shades' length. An assembler could have included a full-sized final diffuser 102c (shown in dashed lines). As illustrated, an assembler took a diffuser of similar dimensions to diffusers 102a and 102b and cut or removed the excess length so that diffuser bar 112a didn't extend past the end of the final shade. A manufacturer can construct diffusers of the present disclosure to a uniform size and dimension, or to a specific and bespoke size and dimension.

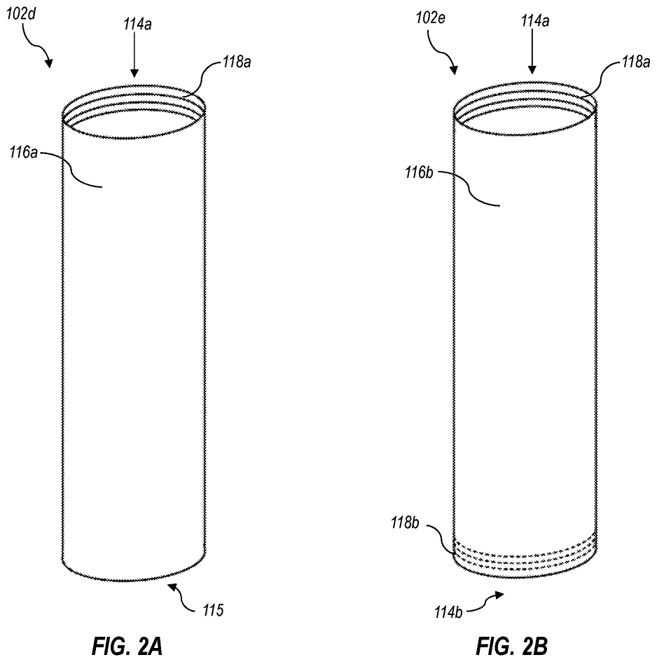

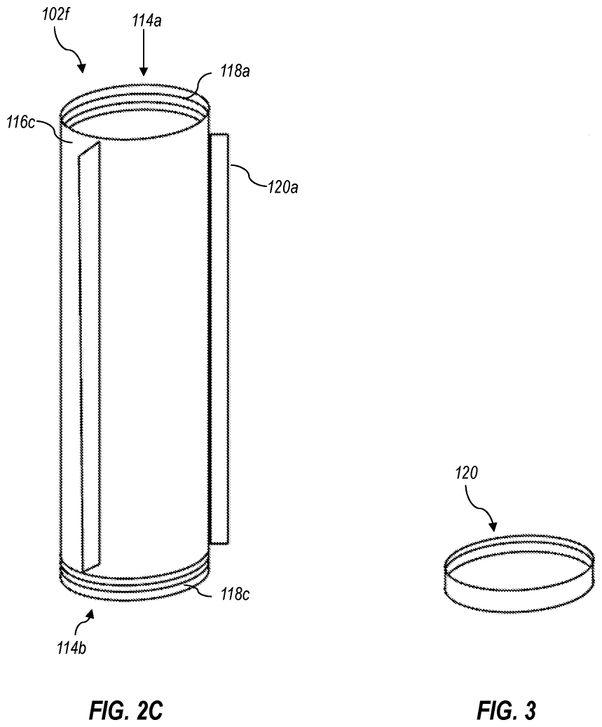

FIGS. 2A-2C illustrate various embodiments of diffusers of the present disclosure. Specifically, FIG. 2A shows diffuser 102d. Diffuser 102d can have opening 114a, defined by the outer shell 116a. Outer shell 116a can have a thickness. A manufacturer can configure the thickness and other characteristics of the outer shell 116a to allow varying amounts of light to transmit through the outer shell 116a. For example, material type, thickness, and texture may be varied independently or together to cause the light emitted from a light element within outer shell 116a to be diffused to accomplish a specific aesthetic or functional goal. In one embodiment, outer shell 116a is thick and does not allow light to pass through while bottom surface 115 is transparent, allowing directional light to pass downwards. In another embodiment, a manufacturer constructs the outer shell 116a with a patterned and varied thickness, allowing diffuser 102d to cast shadows along with the light. Diffuser 102d also can comprise connector 118a. Connector 118a is illustrated as a threaded portion which can couple to corresponding threaded elements of other diffusers or collars of the modular lighting fixtures of the present disclosure. In another embodiment, connector 118a may be clips, snaps, indexing grooves, hook and loop, magnets, or other suitable coupling features.

FIG. 2B illustrates a perspective view of diffuser 102e. Diffuser 102e can have many of the features and characteristics of diffuser 102d. For example, diffuser 102e can have connector 118a and opening 114a. Diffuser 102e may also have opening 114b and connector 118b, which are both disposed on an opposing end of diffuser 102e relative to connector 118a and opening 114a. Thus, diffuser 102e can be a substantially hollow tube structure.

FIG. 2B shows that connector 118b is internally disposed on an inner surface of outer shell 116b. In another embodiment, an assembler can dispose connector 118b (or 118a) on the inner or outer surface of outer shell 116b. A manufacturer can construct a diffuser 102e with connectors on the inside or outside to allow for diffusers to couple to one another to form a diffuser bar with or without the need of additional coupling rings or elements.

FIG. 2C illustrates a perspective view of locking diffuser 102f. Locking diffuser 102f can have any of the characteristics or features of any other diffuser of the present disclosure. For example, locking diffuser 102f can have connector 118a and openings 114a and 114b. Locking diffuser 102f can also comprise connector 118c and fins 120a. As previously mentioned, connector 118c can reside on the outer surface of outer shell 116c. This configuration advantageously allows a plurality of locking diffusers to couple together to form a diffuser bar. Fins 120a can be disposed about the circumferential perimeter of outer shell 116c. As illustrated, three fins are equally spaced around the outer shell 116c. In another embodiment, a manufacturer can include any number of fins (for example, 1, 2, 3, 4, 5, 6, 7, 8, or more than 8). Fins 120a protrude from and extend away from outer surface 116c. During the additive construction of diffuser 102f, the manufacturer can ensure that fins 120a are formed during the same process.

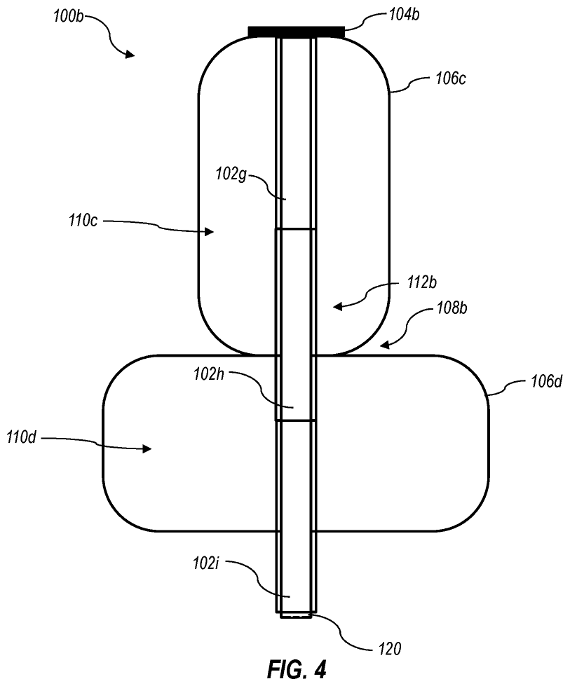

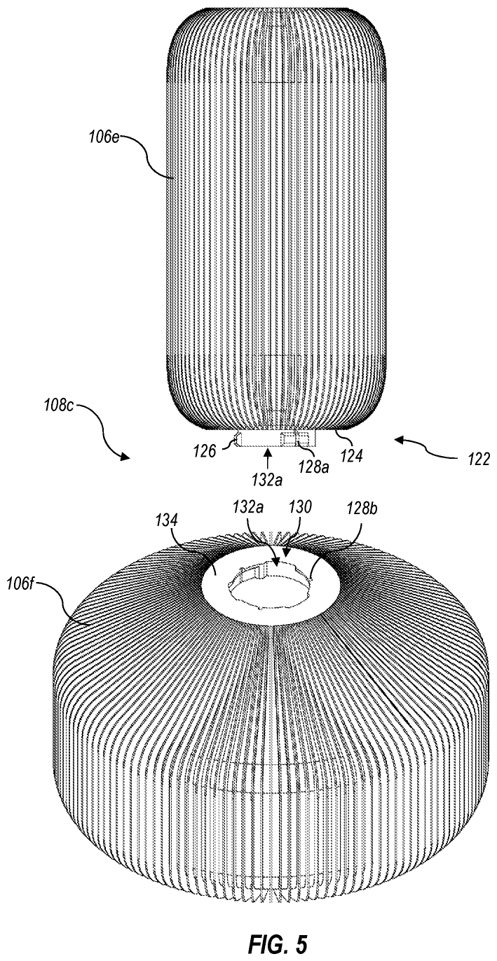

FIG. 2C shows fin 102a, which allows locking diffuser 102f to lock a modular light fixture of the present disclosure such that the shades do not de-couple without removing the diffuser bar. Fins 102a are configured to interface with slots defined by the neck or coupling elements of shades of the present disclosure to inhibit their rotation relative to one another. (See FIGS. 4 and 5).

FIG. 3 illustrates a cap 120. A manufacturer can configure cap 120 to the diffusers of the present disclosure. Cap 120 can threadingly engage or otherwise couple to a diffuser of the present disclosure, ensuring that all light is equally diffused. Cap 120 can be non-transparent, semi-transparent, or fully transparent.

FIG. 4 illustrates a cross section of modular light fixture 100b, including locking diffusers 102g, 102h, and 102i. Locking diffusers 102g, 102h, and 102i selectively couple to each other through connectors (not shown, see FIG. 2C). An assembler can ensure that the fins of each locking diffuser are aligned to form contiguous fins along the entire length of the diffuser bar 112b. An assembler will appreciate that this orientation allows the easy insertion or removal of diffuser bar 112b from within internal spaces 110c and 110d. As previously discussed, the diffuser bar 112b fins interface with slots defined by joint 108b. FIG. 5 illustrates these slots. This interfacing prevents shade 106c from twisting relative to shade 106d, meaning shade 106c and 106d are inseparable until diffuser bard 112b is removed from the modular light fixture 100b. Users of modular light fixture 100b will appreciate that this prevents accidental separation when they hang their modular light fixture 100b.

FIG. 5 illustrates side perspective views of shades 100e and 100f. FIG. 5 is an exploded view of joint 108c. Shade 106e can comprise connection element 122. Connection element 122 can protrude downward and away from the bottom surface 124 of shade 106e. Connection element 122 can comprise one or more indexes 126 and slots 128a. Indexes 126 protrude perpendicular to bottom surface 124, enabling an assembler to interface connection element 122 with neck 130 of shade 106f. Slot 128a is a cutout or opening defined by connection element 122. The dimensions of slot 128a are determined by the dimensions of the fins that will be used on a locking diffuser to ensure a secure fit with minimal give. Connection element 122 defines the dimensions of opening 132a.

FIG. 5 also illustrates shade 106f. Shade 106f can comprise neck 130 which defines opening 132b. Opening s 132a and 132b align and allow the passage of a diffuser bar between the internal spaces defined by shades 106e and 106f. Neck 130 can have an upper surface 134 that abuts bottom surface 124 when shades 106e and 106f are coupled. Bottom surface 124 and upper surface 134 can have magnets (not shown) embedded inside them, allowing an assembler to secure the two shades together. Neck 130 receives coupling element 122 and index 126 interfaces with neck 130 to frictionally secure the two shades together. An assembler can insert coupling element 122 into neck 130 and twist shade 106f relative to shade 106e. This twisting can engage index 126 with neck 130 as well as the magnets embedded within bottom surface 124 with the magnets embedded within upper surface 134. This twist locking procedure also aligned slots 128a and 128b forming a contiguous slot that can receive the fins of a locking diffuser. The size of the innermost circumference of connection element 122 defines the circumference or size of the outer shell of a diffuser.

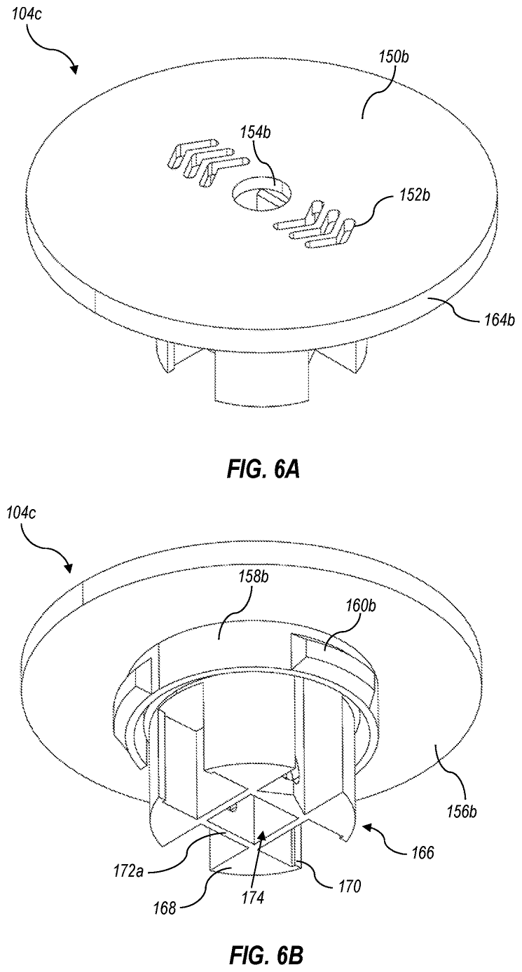

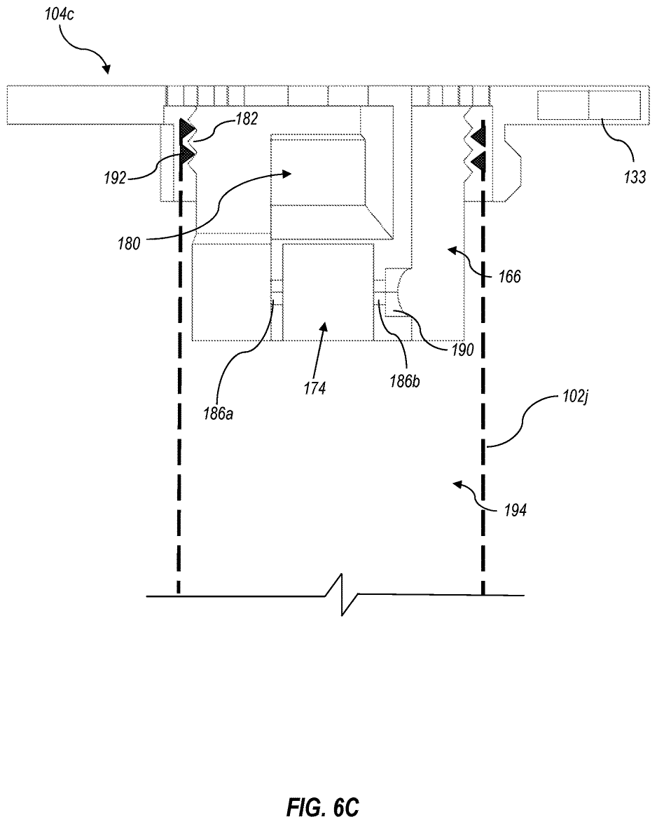

FIG. 6A illustrates a top-perspective view of collar 104c. Collar 104c can include an upper surface 150b, apertures 152b and 154b, and body 164b. Upper surface 150b can be substantially circular. In another embodiment, upper surface 150b can take a different geometric shape, such as a square or triangle. Upper surface 150b can define one or more apertures 152b and 154b. Apertures 152b can allow for the passage of warm air that may build up inside a shade to which collar 104c connects. Aperture 154a can selectively couple to supports, cables, or mounts (not shown) to secure collar 104c to a ceiling, floor, wall, or other support surface. Aperture 154a can also allow for the passage of wires or cables from outside a shade into a shade. Collar 104c can couple with shades of the present disclosure.

FIG. 6B illustrates a bottom perspective view of collar 104c. Collar 104c can include wall 158b, indexes 160b, and bottom surface 156b. Collar 104c can also include structure 166. Structure 166 can comprise one or more corners 168. Each corner 168 can have a ridge 170. Ridge 170 can secure componentry inside collar 104c or act as indexes or slots that interface with componentry. Componentry can include lighting elements, wiring, fasteners, portions of shade, tinted material layers, etc. Support structure 166 can also include one or more panels 172a. Panels 172a can define a center opening 174. Center opening 174 can have one or more apertures defined by panels 172a configured to receive fasteners. Center opening 174 can receive a member (e.g. extruded aluminum) that supports a light element positioned within a modular lighting fixture. The member can be secured to support using apertures defined by the support structure 166. (see FIGS. 6C and 6D, apertures 186a and 186b).

FIG. 6C illustrates a side cross-sectional view of the collar 104c. Diffuser 102j can have a thread 192 (which is analogous to connectors of the present disclosure) that corresponds to thread 182, which allows an assembler to secure the diffuser 102j to collar 104c. As discussed previously, a portion of support structure 166 can be received within space 194, which is defined by the internal volume of the diffuser 102j. Compartment 133 is also shown embedded within the upper surface of collar 104c. A plurality of magnets can reside within compartment 133 or similar compartments spaced around collar 104c.

FIG. 6C also shows apertures 186a and 186b aligned providing a passthrough through center opening 174. An assembler may pass a fastener through apertures 186a and 186b to secure an extrusion or member into center opening 174. This provides a secure anchor point to support a light element of the present disclosure. A light element may be adhered or otherwise secured to the secured extrusion or member. Countersink 190 allows the head of a fastener to sit flush and not protrude into space where additional componentry may be needed.

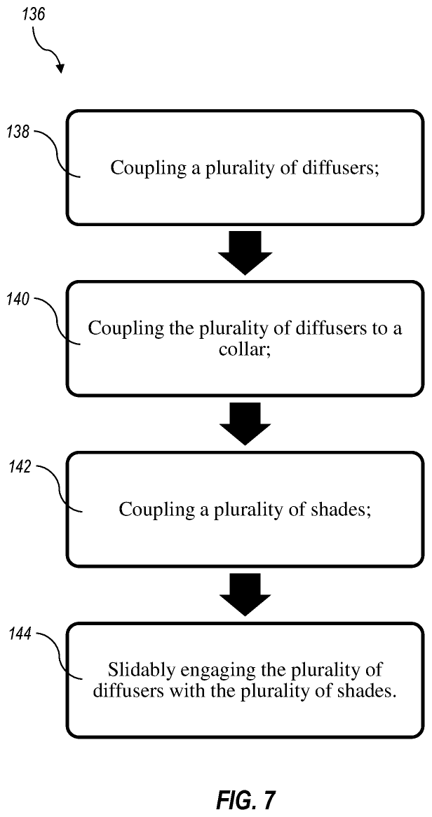

FIG. 7 illustrates a method 136 of assembling a modular light fixture of the present disclosure. For example, FIG. 7 shows that method 136 can comprise act 138 of coupling a plurality of diffusers. Act 138 can include engaging a connector of a first diffuser with a connector of a second diffuser. Act 138 can be repeated for any number of diffusers.

FIG. 7 shows that method 136 can further comprise act 140 of coupling the plurality of diffusers to a collar. Act 140 can include threadingly engaging a connector of a first diffuser with threads disposed on a collar of the present disclosure. In one embodiment, the collar and the first diffuser engagement is clips, clasps, hooks, snaps, or similar.

FIG. 7 shows that method 136 can comprise act 142 of coupling a plurality of shades. Act 140 can include inserting the connection element of a first shade into the neck of a second shade. Act 140 can also include twisting the first shade relative to the second shade to lock the shades together by way of one or more indexes and/or magnets.

FIG. 7 shows that method 136 can also comprise act 144 of slidably engaging the plurality of diffusers with the plurality of shades. Act 144 may include slidably engaging the fins of a diffuser or diffuser bar with slots defined by the connection element of the first shade and the neck of the second shade. Act 144 may also include twisting the collar relative to the first and second shade to engage indexes and/or magnets between the neck of the first shade and the connection element of the second shade.

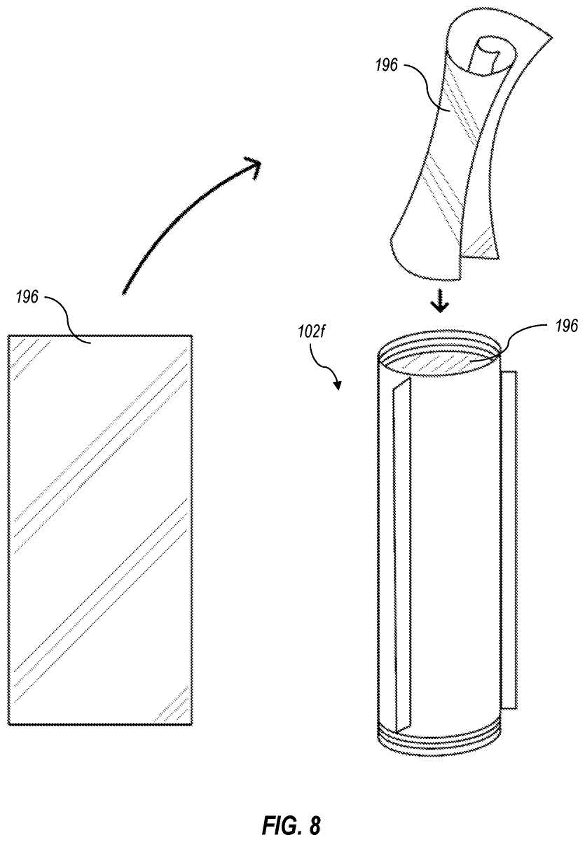

FIG. 8 illustrates a sequence of inserting film 196 into diffuser 102f. An assembler can first roll or fold film 196. The assembler can then insert film 196 into an opening of diffuser 102f. Once inserted, film 196 is free to unfurl inside diffuser 102f and frictionally retain and conform itself inside the inner surface of diffuser 102f. Film 196 can be a transparent or semi-transparent material. Film 196 can be colored or tinted. Thus, an assembler can use film 196 to allow a modular light fixture with a white light to produce light of varying colors without replacing the lighting element. In another embodiment, a manufacturer can construct diffuser 102f with a colored material to accomplish a similar goal of allowing a white light lighting element to provide a colored light to a user. Alternatively, each diffuser can be made with color, rather than using a film. For example, the diffuser may be extruded using colored pellets of any different shade, hue, or chroma of color.

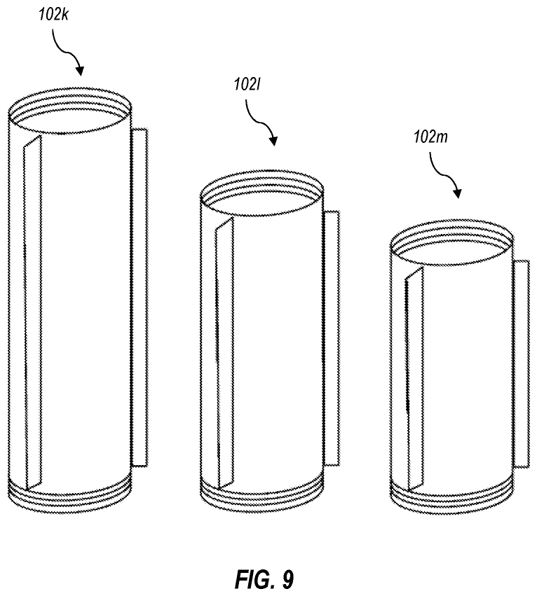

FIG. 9 illustrates diffusers 102k, 1021, and 102m. FIG. 9 illustrates that diffusers of the present disclosure can be of varying length. A manufacturer can produce diffusers longer or shorter to provide functional or aesthetic benefits. For example, a manufacturer can produce a short diffuser, such as diffuser 102m, to allow the diffuser to fit within a short shade. In another example, an assembler can cut a diffuser to a specific length.

The present disclosure teaches innovative modular light fixtures designed for both public and private spaces, emphasizing ease of assembly and customization. The modular design allows users to easily configure and reconfigure the fixtures to suit their aesthetic and functional needs, offering a cost-effective solution for personalized lighting.

Manufacturers and end users can construct these modular light fixtures using various materials through an additive manufacturing or 3D printing process. These processes provide versatility in material choice, allowing for a wide range of design possibilities and ensuring that the fixtures meet diverse aesthetic and functional requirements.

The ability to easily disassemble and reassemble these fixtures for cleaning or reconfiguration is a significant advantage. It enhances the fixtures' longevity and allows users to adapt their lighting to changing needs and preferences. Using magnets ensures that the components stay in place while still being easy to adjust, and the locking diffusers ensure that the modular light fixtures cannot accidentally come apart overtime without the help of an assembler. Overall, the modular light fixtures of the present disclosure provide a forward-thinking approach to lighting design, combining practicality with aesthetic flexibility.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A modular light fixture comprising:
a collar having one or more indexes; and
one or more shades, each of the one or more shades having a neck that defines one or more slots; and
one or more diffusers, each of the one or more diffusers comprising a connector and one or more fins;
wherein the neck selectively engages with the one or more indexes.

2. The modular light fixture of claim 1, wherein a connection element of a first shade of the one or more shades is retained by a neck of a second shade of the one or more shades.

3. The modular light fixture of claim 2, wherein the one or more fins engage with the one or more slots defined by the connection element of the first shade and the neck of the second shade, wherein the one or more fins prevent the first shade from rotating relative to the second shade.

4. A locking diffuser for use in a modular light fixture comprising:
an outer shell;
an opening defined by the outer shell;
a connector;
one or more fins disposed on an outer surface of the outer shell.

5. A collar for use in modular light fixtures comprising:
a body having an upper surface and a lower surface;
one or more walls that extend from the lower surface of the body;
one or more apertures that extend through the body;
a connection element; and
one or more indexes that extend from the one or more walls.

6. The collar of claim 5, further comprising a structure having a threaded portion wherein the structure extends from the lower surface of the body and within a space defined by the one or more walls, wherein a connector of a diffuser selectively engages with the threaded portion.

7. A method of assembling a modular lighting fixture claim 1 comprising:
engaging a first diffuser with a second diffuser;
coupling the first diffuser to the collar;
coupling a first shade to a second shade;
slidably engaging the first and second shades to the first diffuser and the second diffuser;
securing a neck of the first shade to the collar.
